(19) United States
(12) Patent Application Publication
(10) Pub. No.: US 2002/0138639 A1
(43) Pub. Date: Sep. 26, 2002

(54) Protocol device of a protocol system for transmitting messages

(76) Inventors: Klaus David Gradischnig, Reston, VA (US); Michael Tuxen, Munchen (DE)

Correspondence Address: BELL, BOYD & LLOYD, LLC, P. O. BOX 1135, CHICAGO, IL, 60690-1135, US

(21) Appl. No.: 10/019,328

(22) PCT Filed: May 15, 2001
(86) PCT No.: PCT/EP00/04355

(30) Foreign Application Priority Data
Jun. 24, 1999 (DE) 199 29 002.4

(51) Int. Cl. G06F 15/16

(52) U.S. Cl. 709/230

(57) ABSTRACT

Both user data and monitoring information are transmitted in communication protocols. While (message) packets with user data are successively numbered in many protocols, thus ensuring that the user data are transmitted completely and with a protected sequence to the receiver, messages which contain only monitoring information are not normally successively numbered. This situation can lead to monitoring messages being overtaken, and thus to the rejection of current monitoring information. The invention describes how the rejection of current monitoring information can be avoided.

### DESCRIPTION

Protocol device in a protocol system for transmitting messages

1. What technical problem is your invention intended to solve?

2. How has the problem been solved until now?

3. In what way does your invention solve said technical problem (have you indicated the advantages)?

4. What is the special feature of the invention?

5. Exemplary embodiment or embodiments of the invention.

Re 1.

Both user data and monitoring information are transmitted using communications protocols. In this case, many protocols ensure that the user data is transmitted to the receiver complete (that is to say all transmitted data is also received) and with a protected sequence (that is to say in the correct sequence defined by the transmitter). For the user data, this is often done by the transmitter device in the protocol system successively numbering all the user data with a sequence number. (Message) packets which contain only monitoring information are normally not successively numbered, at least packets with certain classes of monitoring information. However, if the monitoring messages are now transmitted by the lower layer without sequence protection then this can lead to monitoring messages overtaking one another. If the fact that this overtaking has taken place is not identified, this means, for the receiver of monitoring information, that, instead of working with up-to-date monitoring information, which is likewise available to it, it operates with obsolete monitoring information since it receives this as if it were up-to-date. This behavior is generally not critical for that monitoring information which confirms message reception, since this information does not become obsolete. However, the rejection of current monitoring information which relates to flow monitoring (for example credit information) due to the use of obsolete information is critical, since this information becomes obsolete very quickly. Dynamic window sizes, which are defined by the receiver, are particularly affected by this.

Insert

Two definitions have been fixed with regard to flow monitoring. The term a credit, which the receiver of user data messages (referred to as SD-PDUs in Q.2110) reserves for the transmitter via a monitoring message in this case means the sequence number (contained in Q.2110 in the parameter N(MR) of a monitoring message, for example an STAT-PDU or USTAT-PDU) of that user data message which is the first which is no longer accepted by the receiver. The term window size means a number of user data items which the receiver is prepared to accept. In this case, the sequence number (contained in Q.2110, in the parameter N(R) of an STAT-PDU or USTAT-PDU) is used as the counting starting point up to which the receiver has already received and acknowledged all the messages with a lower sequence number.

The invention now describes how the rejection of current control information is avoided. This describes, in particular, how existing protocols which do not solve the problem can be upgraded so that they do solve this problem.

It could be suggested that this problem need not be dealt with if the lower protocol layer guarantees sequence-protected transmission. However, if it is intended to set up a multilink connection using such a layer, then it must also be expected that messages will overtake one another in a layer such as this.

Re 2.

If a restriction is imposed such that the receiver cannot withdraw a credit once again once it has been allocated, then the abovementioned problem can easily be solved simply by not processing monitoring information which contravenes this rule. This corresponds to the solution in the TCP/IP protocol. This also includes the situation where the window size is constant.

A further simple possibility for solving the problem is to successively number all the monitoring information and then to treat the monitoring information in an analogous manner to the user data. However, it is difficult to introduce this retrospectively into the protocols, since the message format would generally need to be changed for numbering. However, this is generally unacceptable for compatibility reasons when upgrading existing protocols.

The capacity to withdraw the credit is an important characteristic in some protocols, for example SSCOP. At the moment, the problem appears to be insoluble for protocols such as these.

Re 3.

In the case of the solution specified here, the receiver of the monitoring message can always decided whether this monitoring message received by it contains information which is newer than its current information state. It is thus impossible for older information to overwrite more current information when messages overtake one another.

In order to decide whether information obtained from a received monitoring message is newer than the already available information. Protocol information (monitoring information which is used for monitoring the user data messages, for example confirming reception of user data messages, indicating that user data messages have not been received or containing the sequence number of that message up to which all messages have been received without any gaps) is used, provided this is possible. If the transmission sequence cannot be reconstructed on the basis of the protocol information contained in the monitoring messages, then the only monitoring messages, then the only monitoring information items which are additionally successively number are those for which this is absolutely essential, and which allow such introduction.

Re 4.

One special feature of the invention is the skillful combination of a message format change which is compatible with the existing protocol, with analysis of the protocol, in order to allow the receiver of the monitoring information to reconstruct the time sequence of transmission of the monitoring information. It is thus possible to reject old information.

Re 5.

The following text describes three exemplary embodiments, which are all based on the SSCOP protocol. SSCOP, defined in Q.2110, assumes that the lower layer transmits the data with sequence protection. As discussed in 1, the problem under discussion thus does not occur here. However, SSCOP is at present being upgraded in order to have multilink compatibility and to function via a lower layer, which does not ensure sequence-protected transmission. This corresponds to the MSSCOP (the draft Q.2111 at the Standard before the start of the meeting of ITU-T-working party 5/11 and the notice of the Study Questionnaire 15/11, Washington, Jun. 28 to Jul. 1, 1999), as is currently being discussed in the ITU. However, the problem under discussion here is not solved there.

Exemplary Embodiment 1

The simplest method consists of no longer having the capability to reduce the credit in the MSSCOP. However, this represents a major restriction of the protocol. On receiving an STAT-PDU, the credit information would be rejected if the received credit were less than the current credit.

Exemplary Embodiment 2

In the MSSCOP protocol (the draft Q.2111 at the Standard before the start of the meeting of ITU-T-working party 5/11 and the notice of the Study Questionnaire 15/11, Washington, Jun. 28 to Jul. 1, 1999), as is currently under discussion, the transmission sequence can be reconstructed only from the protocol information in the STAT-PDUs and USTAT-PDUs. No message format need be changed in this exemplary embodiment.

In SSCOP, the transmitter (of the user data) uses the protocol information which is contained in the list elements and in the parameter N(R) of the received STAT- and USTAT-PDUs as follows:

When already transmitted user data messages are confirmed by list elements or the parameter N(R) of the received STAT- and USTAT-PDUs without any gaps up to a specific sequence number, the variable VT(A) of the transmitter is changed such that it once again contains the value of the next (“oldest”) message to be confirmed.

Furthermore, the information in the list elements is used to decide whether certain messages in the transmission buffer must be retransmitted or have been confirmed by the receiver. The parameter N(R) is also used for the latter. If messages have been confirmed, they can be removed from the transmission buffer, otherwise this is not allowed by the user of the SSCOP. (In this case, the SSCOP parameter Clear Buffer has the value FALSE).

According to the invention, an additional SSCOP Status Variable VT(H) is now introduced for the transmitter. The new variable VT(H) in each case stores the largest last list element of all the received STAT-PDUs and USTAT-PDUs (the last list element in the STAT-PDU indicates the highest SD-PDU expected by the receiver, assuming that the STAT-PDU contains any list elements at all, and, in an USTAT-PDU, the last list element is used to signal the first SD-PDU received after the reception gap signaled by the USTAT-PDU.

If a received STAT-PDU does not contain any list elements, then the parameter N(R) contained in the STAT-PDU is used for adaptation of the variable VT(H) provided it is greater than the current value of the variable VT(H) (Note: USTATs always contain two, and only two list elements, which signal the gap to be signaled. N(R) in a USTAT is thus always “less” than the list elements contained.

The processing of received POLL-PDUs and STAT-PDUs as well as the administration of the new status variables VT(H) are based on the following rules:

When an USTAT-PDU is received, then the credit information is rejected if the last list element of this message, namely List Element 2<VT(H). Otherwise, the credit information is processed and VT(H)=List Element 2 is set.

When an STAT-PDU is received, the credit information is rejected if the last list element List Element L<VT(H). Otherwise, the credit information is used and VT(H)=List Element L is set. However, if no list element is included, the credit information is rejected if N(R)<VT(H), otherwise, the credit information is used and VT(H)=N(R) is set.

Exemplary Embodiment 3

Upgrading of the SSCOP and hence also of the MSSCOP, is currently under discussion, to allow the receiver to send an STAT-PDU without this being a direct response to a POLL-PDU. (In the MSSCOP, these STAT-PDUs would replace the currently defined/discussed CREDIT-PDUs.) This is intended to make it possible for the receiver to transmit credit information whenever this appears to be worthwhile for the receiver. To do this, the receiver generates an STAT-PDU using the new credit information. Since the status of the receiver does not need to change between the transmission of a number of STAT-PDU in one poll cycle, and the last list element and/or the parameter N(R) may thus remain the same, it is necessary to successively number the STAT-PDUs in the same poll cycle. This is done using the STAT sequence numbers. Otherwise, this exemplary embodiment is an extension to exemplary embodiment 2.

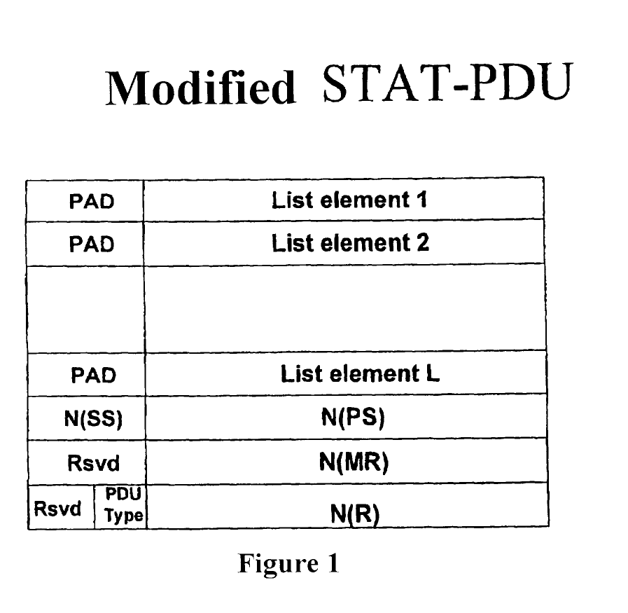

The SSCOP-PDU parameters N(SS) and the SSCOP Status Variable VR(SS) are introduced. When generating an STAT-PDU, N(SS) is set to the value VR(SS). VR(SS) is the next STAT sequence number which is used for successively numbering the STAT-PDUs within a pole cycle (one poll cycle is the time between the reception of two POLL-PDUs). The modified STAT-PDU format is shown in FIG. 1. Since N(SS) is written to a field which is currently identified as being reserved, an unmodified SSCOP protocol machine can also process such a message, since it does not process N(SS).

If a POLL-PDU with a new poll sequence number is received, then this is dealt with as normal. The only difference is that, VR(SS)=0 is also set before an STAT-PDU is generated. If a further STAT-PDU is now intended to be generated within one poll cycle, in order to modify the credit, then this is done only if VR(SS)<255. Otherwise, no such STAT-PDU is generated. (However, this is an acceptable restriction and is in any case better than not allowing any spontaneous modification of the credit at all.) If VR(SS)<255, VR(SS) is incremented by 1, and an STAT-PDU is then generated.

Furthermore, two further SSCOP Status Variables are also required:

VT(SS), this is the STAT sequence number of the most recently received STAT-PDU in the current poll cycle, or 0 if none has yet been received.

VT(H), this is the greatest last list element of all the received STAT-PDUs and USTAT-PDUS.

The processing of received POLL-PDUs and STAT-PDUs as well as the administration of these new status variables are based on the following rules:

When an USTAT-PDU is received, then the credit information is rejected if the List Element 2<VT(H) Otherwise, the credit information is processed, and VT(H)=List Element 2 is set.

When an STAT-PDU is received, then VT(SS)=0 is set, provided VT(PA)<N(PS) If, now, N(SS)<VT(SS), then the credit information is rejected.

If N (SS)≧VT(SS) then VT(SS)=N(SS) is set, and the credit information is rejected if the last list element L<VT(H). Otherwise, the credit information is used VT(H) List Element L is set.

1. A protocol device in a protocol system for transmitting messages,
characterized in that
the protocol device uses the protocol information which is contained in a monitoring message received by it to determine whether this monitoring message contains information which is newer than the current information state in the protocol device, and updates, or does not update, its information state on the basis of this decision.

2. The protocol device as claimed in claim 1,
characterized in that
said protocol device additionally successively numbers those monitoring messages for which it cannot reconstruct the sequence of the received monitoring messages on the basis of said protocol information.

3. The protocol device as claimed in claim 1 or 2,
characterized in that
the monitoring messages are messages for flow monitoring.
